(19) United States
(12) Patent Application Publication
(10) Pub. No.: US 2019/0228009 A1
(43) Pub. Date: Jul. 25, 2019

(54) INFORMATION PROCESSING SYSTEM AND INFORMATION PROCESSING METHOD

(71) Applicant: HITACHI, LTD., Tokyo (JP)

(72) Inventors: Kazushi NAKAGAWA, Tokyo (JP); Toshiyuki ARITSUKA, Tokyo (JP); Kazuhisa FUJIMOTO, Tokyo (JP); Satoru WATANABE, Tokyo (JP); Yoshifumi FUJIKAWA, Tokyo (JP)

(73) Assignee: HITACHI, LTD., Tokyo (JP)

(21) Appl. No.: 16/329,335

(22) PCT Filed: Feb. 2, 2018
(86) PCT No.: PCT/JP2018/003703

§ 371 Date: Feb. 28, 2019

(30) Foreign Application Priority Data
Feb. 3, 2017 (JP) PCT/JP2017/004083

(51) Int. Cl. G06F 16/2455; G06F 16/2453; G06F 16/2458; G06F 9/50; G06F 9/48; G06F 9/38

(52) U.S. Cl. CPC G06F 16/2455; G06F 16/24532; G06F 16/24542; G06F 9/38; G06F 9/5038; G06F 9/48; G06F 16/2471

(57) ABSTRACT

An accelerator is mounted on each server which is a worker node of a distributed DB system; a query generated by an application of an application server is divided into a first task that should be executed by the accelerator and a second task that should be executed by software and is allocated to the server of the distributed DB system; the server causes the accelerator to execute the first task, and executes the second task based on the software.

### TECHNICAL FIELD

The present invention relates to an information processing system and an information processing method, and is suitable for application to an analysis system that analyzes big data, for example.

### BACKGROUND ART

In recent years, the use of big data is expanding. Although analysis of the big data is necessary in the case of using big data, it is considered that an application of a scale-out distributed database such as Hadoop or Spark will be mainstream in the future in the analysis field of big data. Further, a need for self-service analysis of interactive and short Turn Around Time (TAT) using big data is also increasing for quick decision making.

PTL 1 discloses a technique that generates each query based on the processing capability of each database server, which is a coordinator server connected to a plurality of distributed database servers each including a database that stores XLM data.

### PRIOR ART LITERATURE

### Patent Literature

PTL 1: JP-A-2009-110052

### SUMMARY OF INVENTION

### Technical Problem

Here, although a large number of nodes are required for securing performance in order to process a large amount of data at high speed in a distributed database system, as a result, there is a problem that the system scale is increased and introduction cost and maintenance cost are increased.

A method that reduces the number of nodes and prevents the system scale by installing an accelerator in a node of a distributed database system and improving per-node performance is considered as one of methods for solving such problem. In practice, many accelerators with a same function as an Open-Source Software (OSS) database engine have been announced at research level, and it is considered that the performance of the node can be improved by using such accelerators.

However, this kind of accelerator is premised on some system alterations, and there is no accelerator available without altering the general database engine so far.

Here, in recent years, there is a movement (Apache Arrow) to extend an user-defined function (UDF) of an OSS Apache distributed database engine (Spark, Impala and the like), and an environment that achieves an OSS distributed database accelerator without an alteration of a database engine is being established. Meanwhile, when the user-defined function is used, there still remains a problem that an alteration of an application that generates a Structured Query Language (SQL) query is necessary.

The invention has been made in view of the above points, an object is to propose an information processing technique that can prevent increase in the system scale for high-speed processing of large capacity data without performing an alteration of an application and prevent increase in introduction cost and maintenance cost.

### Solution to Problem

In order to solve such problem, in one embodiment of the invention, an accelerator is installed in each server which is a worker node of a distributed DB system. A query generated by an application of an application server is divided into a first task that should be executed by an accelerator and a second task that should be executed by software, and is distributed to a server of a distributed DB system. The server causes the accelerator to execute the first task and executes the second task based on the software.

### Advantageous Effect

According to one embodiment of the invention, it is possible to provide a technique for high-speed processing of large volume data.

### BRIEF DESCRIPTION OF DRAWINGS

FIG. 1 is a block diagram showing a hardware configuration of an information processing system according to a first embodiment and a second embodiment.

FIG. 2 is a block diagram showing a logical configuration of the information processing system according to the first embodiment and the second embodiment.

FIG. 3 is a conceptual diagram showing a schematic configuration of an accelerator information table.

FIG. 4 is a diagram provided for explaining a conversion of an SQL query by an SQL query conversion unit.

FIG. 5 is a flowchart showing a processing procedure of query conversion processing.

FIG. 6 is a flowchart showing a processing procedure of processing executed by a master node server.

FIG. 7 is a flowchart showing a processing procedure of Map processing executed by a worker node server.

FIG. 8 is a flowchart showing a processing procedure of Reduce processing executed by the worker node server.

FIG. 9 is a sequence diagram showing a processing flow at the time of analysis processing in the information processing system.

FIG. 10 is a sequence diagram showing a processing flow at the time of the Map processing in the worker node server.

FIG. 11 is a flowchart showing a processing procedure of the Map processing executed by the worker node server in the information processing system according to the second embodiment.

FIG. 12 is a sequence diagram showing a flow of the Map processing executed by the worker node server in the information processing system according to the second embodiment.

FIG. 13 is a block diagram showing another embodiment.

FIG. 14 is a block diagram showing yet another embodiment.

FIG. 15 is a block diagram showing a logical configuration of an information processing system according to a third embodiment.

FIG. 16 is a conceptual diagram provided for explaining a standard query plan and a converted query plan.

FIG. 17 is a sequence diagram showing a processing flow at the time of analysis processing in the information processing system.

FIG. 18 is a partial flow chart provided for explaining filter processing.

FIG. 19 (1) and FIG. 19 (2) are diagrams provided for explaining the filtering processing.

FIG. 20 is a partial flow chart provided for explaining scan processing.

### DESCRIPTION OF EMBODIMENTS

Hereinafter, one embodiment of the invention is described in detail with reference to drawings.

### (1) First Embodiment

(1-1) Configuration of Information Processing System according to the Present Embodiment

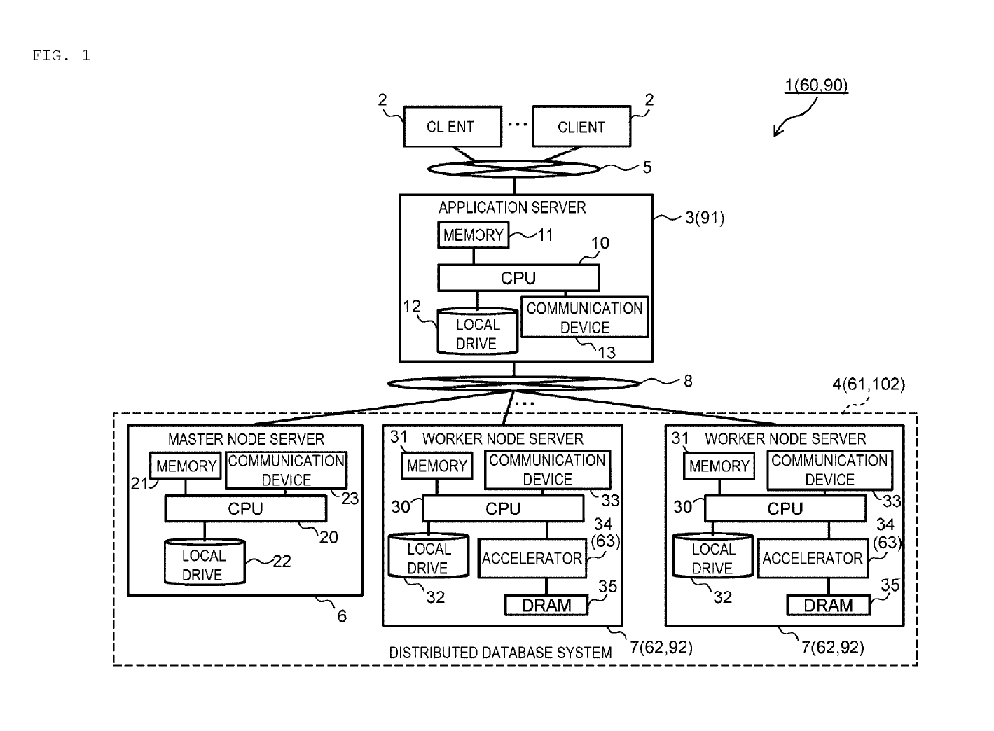

1 denotes an information processing system according to the present embodiment as a whole in FIG. 1. The information processing system is an analysis system which performs big data analysis.

In practice, the information processing system 1 includes one or a plurality of clients 2, an application server 3, and a distributed database system 4. Further, each client 2 is connected to the application server 3 via a first network 5 such as Local Area Network (LAN) or Internet.

Further, the distributed database system 4 includes a master node server 6 and a plurality of worker node servers 7. The master node server 6 and the worker node server 7 are respectively connected to the application server 3 via a second network 8 such as LAN or Storage Area Network (SAN).

The client 2 is a general-purpose computer device used by a user. The client 2 transmits a big data analysis request which includes an analysis condition specified based on a request from an user operation or an application mounted on the client 2 to the application server 3 via the first network 5. Further, the client 2 displays an analysis result transmitted from the application server 3 via the first network 5.

The application server 3 is a server device that has a function of generating an SQL query used for acquiring data necessary for executing analysis processing requested from the client 2 and transmitting the SQL query to the master node server 6 of the distributed database system 4, executing the analysis processing based on a SQL query result transmitted from the master node server 6, and displaying the analysis result on the client 2.

The application server 3 includes a Central Processing Unit (CPU) 10, a memory 11, a local drive 12, and a communication device 13.

The CPU 10 is a processor that governs overall operation control of the application server 3. Further, the memory 11 includes, for example, a volatile semiconductor memory and is used as a work memory of the CPU 10. The local drive 12 includes, for example, a large-capacity nonvolatile storage device such as a hard disk device or Solid State Drive (SSD) and is used for holding various programs and data for a long period.

The communication device 13 includes, for example, Network Interface Card (NIC), and performs protocol control at the time of communication with the client 2 via the first network 5 and at the time of communication with the master node server 6 or the worker node server 7 via the second network 8.

The master node server 6 is a general-purpose server device (an open system) which functions as a master node, for example, in Hadoop. In practice, the master node server 6 analyzes the SQL query transmitted from the application server 3 via the second network 8, and divides the processing based on the SQL query into tasks such as Map processing and Reduce processing. Further, the master node server 6 creates an execution plan of these task of the Map processing (hereinafter referred to as a Map processing task) and task of the Reduce processing (hereinafter referred to as a Reduce processing task), and transmits execution requests of these Map processing task and Reduce processing task to each worker node server 7 according to the created execution plan. Further, the master node server 6 transmits the processing result of the Reduce processing task transmitted from the worker node server 7 to which the Reduce processing task is distributed as the processing result of the SQL query to the application server 3.

Similar to the application server 3, the master node server 6 includes a CPU 20, a memory 21, a local drive 22, and a communication device 23. Since functions and configurations of the CPU 20, the memory 21, the local drive 22, and the communication device 23 are the same as corresponding portions (the CPU 10, the memory 11, the local drive 12, and the communication device 13) of the application server 3, detailed descriptions of these are omitted.

The worker node server 7 is a general-purpose server device (an open system) which functions as a worker node, for example, in Hadoop. In practice, the worker node server 7 holds a part of the distributed big data in a local drive 32 which will be described later, executes the Map processing and the Reduce processing according to the execution request of the Map processing task and the Reduce processing task (hereinafter referred to as a task execution request) given from the master node server 6, and transmits the processing result to other worker node server 7 and the master node server 6.

The worker node server 7 includes an accelerator 34 and a Dynamic Random Access Memory (DRAM) 35 in addition to a CPU 30, a memory 31, a local drive 32, and a communication device 33. Since functions and configurations of the CPU 30, the memory 31, the local drive 32, and the communication device 33 are the same as corresponding portions (the CPU 10, the memory 11, the local drive 12, and the communication device 13) of the application server 3, detailed descriptions of these are omitted. Communication between the master node server 6 and the worker node server 7 and communication between the worker node servers 7 are all performed via the second network 8 in the present embodiment.

The accelerator 34 includes a Field Programmable Gate Array (FPGA) and executes the Map processing task and the Reduce processing task defined by a prescribed format user-defined function included in the task execution request given from the master node server 6. Further, DRAM 35 is used as a work memory of the accelerator 34. In the following description, it is assumed that all the accelerators installed in each worker node server have the same performances and functions.

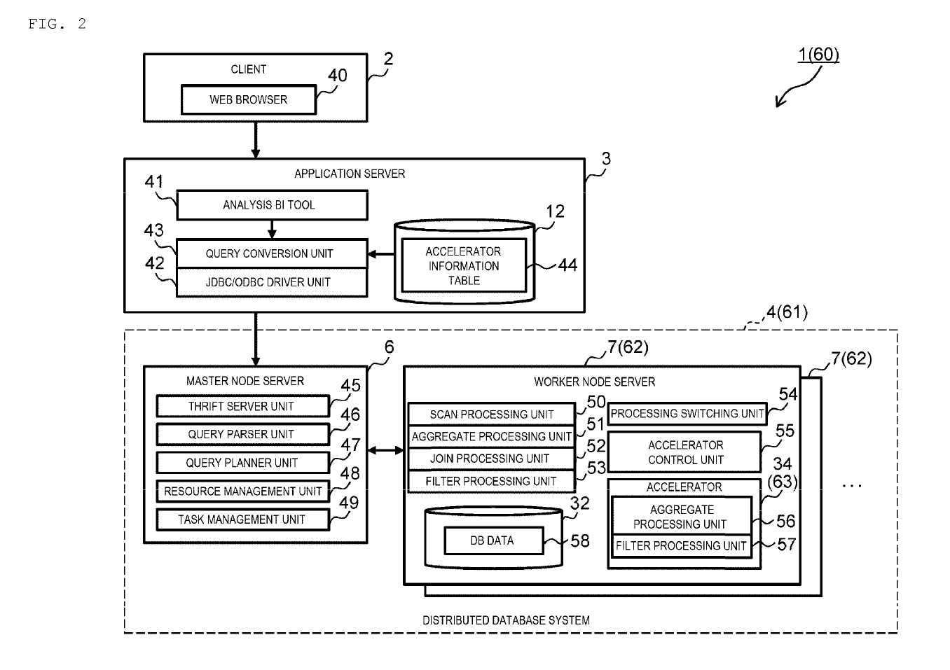

FIG. 2 shows a logical configuration of such information processing system 1. As shown in FIG. 2, Web browsers 40 are mounted on each client 2, respectively. The Web browser 40 is a program having a function similar to that of a general-purpose Web browser, and displays an analysis condition setting screen used for setting the analysis condition by a user, an analysis result screen used for displaying the analysis result, and the like.

Further, an analysis Business Intelligence (BI) tool 41, a Java (registered trademark) Database Connectivity/Open Database Connectivity (JDBC/ODBC) driver 42, and a query conversion unit 43 are mounted on the application server 3. The analysis BI tool 41, the JDBC/ODBC driver 42, and the query conversion unit 43 are functional units which are embodied by executing a program (not shown) stored in the memory 11 (FIG. 1) by the CPU 10 (FIG. 1) of the application server 3.

The analysis BI tool 41 is an application which has a function of generating the SQL query used for acquiring database data necessary for analysis processing according to the analysis condition set on the analysis condition setting screen displayed on the client 2 by a user from the distributed database system 4. The analysis BI tool 41 executes the analysis processing in accordance with such analysis condition based on the acquired database data and causes the client to display the analysis result screen including the processing result.

Further, the JDBC/ODBC driver 42 functions as an interface (API: Application Interface) for the analysis BI tool 41 to access the distributed database system 4.

The query conversion unit 43 inherits a class of the JDBC/ODBC driver 42 and is implemented as a child class to which a query conversion function is added. The query conversion unit 43 has a function of converting the SQL query generated by the analysis BI tool 41 into the SQL query explicitly divided into a task that should be executed by the accelerator 34 (FIG. 1) of the worker node server 7 and other task with reference to an accelerator information table 44 stored in the local drive 12.

In practice, the accelerator information table 44 in which hardware specification information of the accelerator 34 mounted on the worker node server 7 of the distributed database system 4 is previously stored by a system administrator and the like is stored in the local drive 12 of the application server 3 in the present embodiment.

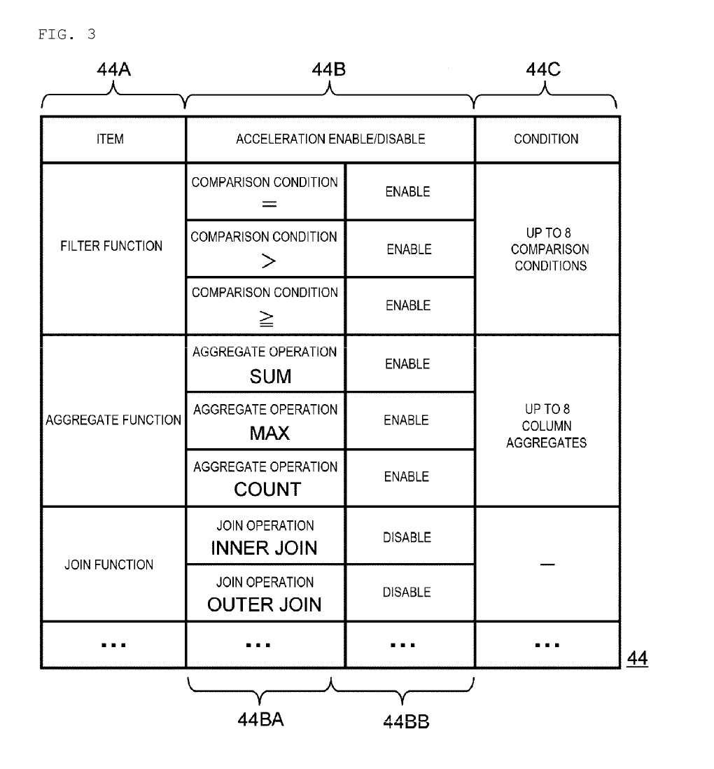

As shown in FIG. 3, the accelerator information table 44 includes an item column 44 A, an acceleration enable/disable column 44 B, and a condition column 44 C. Further, the item column 44 A stores all the functions supported by the accelerator 34, and the condition column 44C stores conditions for the corresponding functions. Further, the acceleration enable/disable column 44 B is divided into a condition/processing column 44 BA and an enable/disable column 44 BB. The condition/processing column 44 BA stores the conditions in the corresponding functions and specific processing contents in the corresponding functions. The enable/disable column 44 BB stores information showing whether or not the corresponding conditions or processing contents are supported (“enable” in the case of supporting and “disable” in the case of not supporting).

Further, the query conversion unit 43 divides the SQL query generated by the analysis BI tool 41 into the Map processing task and the Reduce processing task with reference to the accelerator information table 44. The Map processing task and the Reduce processing task which can be executed by the accelerator 34 are defined (described) by the user-defined function among the Map processing task and the Reduce processing task. The SQL query defined (described) by a format (that is, SQL) which can be recognized by software mounted on the worker node server 7 of the distributed database system 4 is generated for other task (that is, the SQL task generated by the analysis BI tool 41 is converted into such SQL).

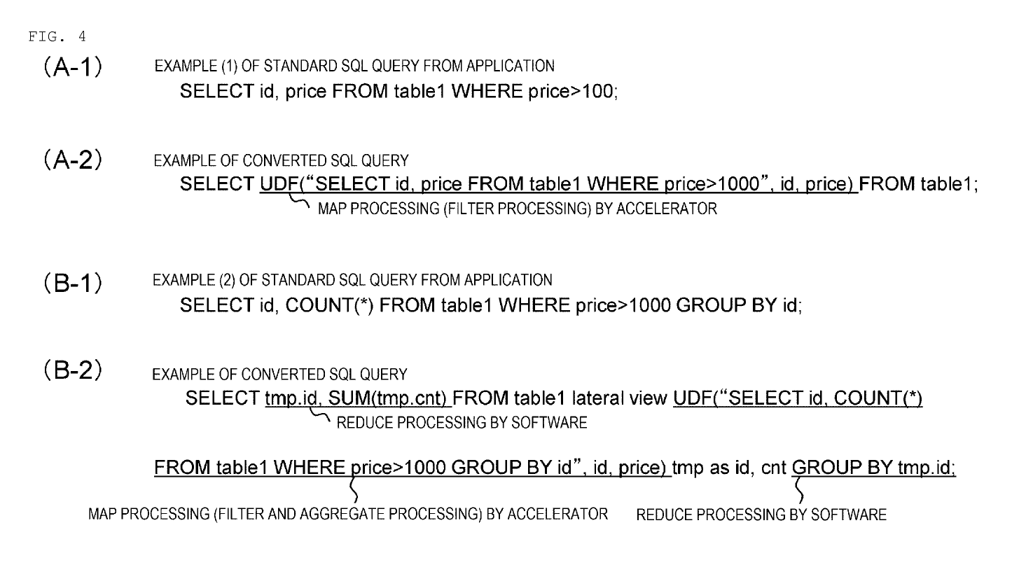

For example, when the SQL query generated by the analysis BI tool 41 only includes the Map processing (filter processing) task as shown in FIG. 4 (A-1) and the Map processing task can be executed by the accelerator 34 according to the hardware specification information of the accelerator 34 stored in the accelerator information table 44, the query conversion unit 43 converts the SQL query into an SQL query in which the Map processing task is defined by the user-defined function as shown in FIG. 4 (A-2).

FIG. 4 (A-1) is a description example of an SQL query that requests a Map processing execution of “selecting ‘id’ and ‘price’ of a record where ‘price’ is larger than ‘1000’ from ‘table 1’”. A part of “UDF (“SELECT id, price FROM table 1 WHERE price>1000”)” in FIG. 4 (A-2) shows the Map processing task defined by such user-defined function.

Further, when the SQL query generated by the analysis BI tool 41 includes the Map processing task and the Reduce processing task as shown in FIG. 4 (B-1) and the Map processing (the filter processing and aggregate processing) task among the Map processing task and the Reduce processing task can be executed by the accelerator 34 according to the hardware specification information of the accelerator 34 stored in the accelerator information table 44, the query conversion unit 43 converts the SQL query into an SQL query in which the Map processing task is defined by the user-defined function and other task is defined by the SQL as shown in FIG. 4 (B-2).

FIG. 4 (B-1) is a description example of an SQL query that requests a series of processing executions of “only selecting a record where price is larger than ‘1000’ from ‘table 1’, grouping by ‘id’ and counting the number of grouped ‘id’”. In FIG. 4 (B-2), a part of “UDF (“SELECT id, COUNT (*) FROM table 1 WHERE price>1000 GROUP BY id”)” shows the Map processing (the filter processing and the aggregate processing) task defined by this user-defined function, and a part of “SUM (tmp.cnt)” and “GROUP BY tmp.id” shows the Reduce processing task that should be executed by the software processing.

Meanwhile, a Thrift server unit 45, a query parser unit 46, a query planner unit 47, a resource management unit 48, and a task management unit 49 are mounted on the master node server 6 of the distributed database system 4 as shown in FIG. 2. The Thrift server unit 45, the query parser unit 46, the query planner unit 47, the resource management unit 48, and the task management unit 49 are functional units that are embodied by executing corresponding programs (not shown) stored in the memory 21 (FIG. 1) by the CPU (FIG. 1) of the master node server 6 respectively.

The Thrift server unit 45 has a function of receiving the SQL query transmitted from the application server 3 and transmitting an execution result of the SQL query to the application server 3. Further, the query parser unit 46 has a function of analyzing the SQL query received from the application server 3 by the Thrift server unit 45 and converting the SQL query into an aggregate of data structures handled by the query planner unit 47.

The query planner unit 47 has a function of dividing the content of the processing specified by the SQL query into respective Map processing task and Reduce processing task and creating execution plans of these Map processing task and Reduce processing task based on the analysis result of the query parser unit 46.

Further, the resource management unit 48 has a function of managing specification information of hardware resources of each worker node server 7, information relating to the current usage status of the hardware resource collected from each worker node server 7, and the like, and determining the worker node server 7 that executes the Map processing task and the Reduce processing task according to the execution plan created by the query planner unit 47 for each task respectively.

The task management unit 49 has a function of transmitting a task execution request that requests the execution of such Map processing task and Reduce processing task to the corresponding worker node server 7 based on the determination result of the resource management unit 48.

On the other hand, a scan processing unit 50, an aggregate processing unit 51, a join processing unit 52, a filter processing unit 53, a processing switching unit 54, and an accelerator control unit 55 are mounted on each worker node server 7 of the distributed database system 4. The scan processing unit 50, the aggregate processing unit 51, the join processing unit 52, the filter processing unit 53, the processing switching unit 54, and the accelerator control unit 55 are functional units that are embodied by executing corresponding programs (not shown) stored in the memory (FIG. 1) by the CPU 30 (FIG. 1) of the worker node server 7, respectively.

The scan processing unit 50 has a function of reading necessary database data 58 from the local drive 32 and loading the necessary database data 58 into the memory 31 (FIG. 1) according to the task execution request given from the master node server 6. Further, the aggregate processing unit 51, the join processing unit 52, and the filter processing unit 53 have functions of executing an aggregate processing (SUM, MAX, or COUNT, and the like), a join processing (INNER JOIN or OUTER JOIN, and the like) or a filtering processing on the database data 58 read into the memory 31 according to the task execution request given from the master node server 6, respectively.

The processing switching unit 54 has a function of determining whether the Map processing task and the Reduce processing task included in the task execution request given from the master node server 6 should be executed by software processing using the aggregate processing unit 51, the join processing unit 52 and/or the filter processing unit 53 or should be executed by hardware processing using the accelerator 34. When a plurality of tasks are included in the task execution request, the processing switching unit 54 determines whether each task should be executed by software processing or should be executed by hardware processing.

In practice, when the task is described by the SQL in the task execution request, the processing switching unit 54 determines that the task should be executed by the software processing and causes the task to be executed in a necessary processing unit among the aggregate processing unit 51, the join processing unit 52 and the filter processing unit 53. Further, when the task is described by the user-defined function in the task execution request, the processing switching unit 54 determines that the task should be executed by the hardware processing, calls the accelerator control unit 55, and gives the user-defined function to the accelerator control unit 55.

The accelerator control unit 55 has a function of controlling the accelerator 34. When called from the processing switching unit 54, the accelerator control unit 55 generates one or a plurality of commands (hereinafter referred to as accelerator command) necessary for causing the accelerator 34 to execute the task (the Map processing task or the Reduce processing task) defined by the user-defined function based on the user-defined function given from the processing switching unit 54 at that time. Then, the accelerator control unit 55 sequentially outputs the generated accelerator commands to the accelerator, and causes the accelerator 34 to execute the task.

The accelerator 34 has various functions for executing the Map processing task and the Reduce processing task. FIG. 2 is an example of a case where the accelerator 34 has a filter processing function and an aggregate processing function and shows a case where the accelerator 34 includes an aggregate processing unit 56 and a filter processing unit 57 which have functions similar to that of the aggregate processing unit 51 and the filter processing unit 53, respectively. The accelerator 34 executes necessary aggregate processing and filter processing by the aggregate processing unit 56 and the filter processing unit 57 according to the accelerator command given from the accelerator control unit 55, and outputs the processing result to the accelerator control unit 55.

Thus, the accelerator control unit 55 executes a summary processing that summarizes a processing result of each accelerator command output from the accelerator 34. When the task executed by the accelerator 34 is the Map processing task, the worker node server 7 transmits the processing result to other worker node server 7 to which the Reduce processing is allocated, and when the task executed by the accelerator 34 is the Reduce processing task, the worker node server 7 transmits the processing result to the master node server 6.

### (1-2) Contents of Various Processing

Next, processing contents of various processing executed in the information processing system 1 will be described.

### (1-2-1) Query Conversion Processing

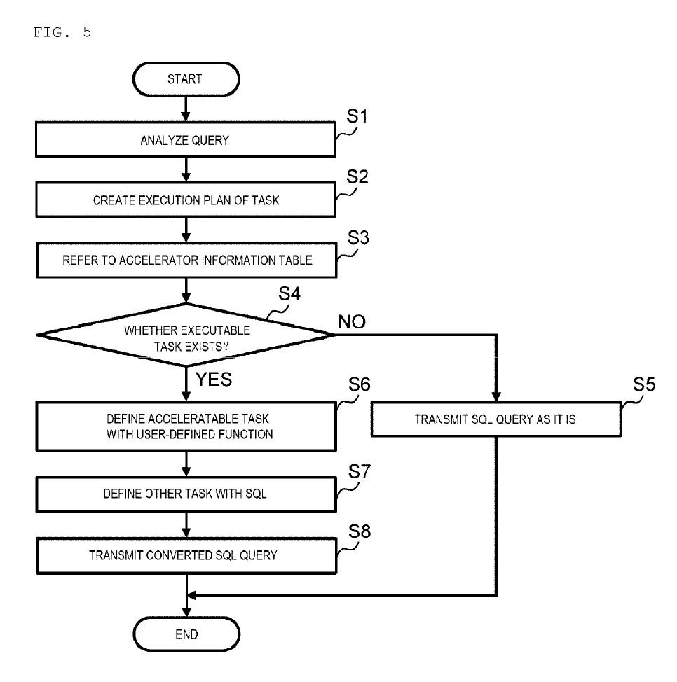

FIG. 5 shows a processing procedure of the query conversion processing executed by the query conversion unit 43 when the SQL query is given from the analysis BI tool 41 (FIG. 2) of the application server 3 to the query conversion unit 43 (FIG. 2).

When the SQL query is given from the analysis BI tool 41, the query conversion unit 43 starts the query conversion processing, firstly analyzes the given SQL query, and converts the SQL query content into an aggregate of data structures handled by the query conversion unit 43 (S1).

Then, the query conversion unit 43 divides the content of the processing specified by the SQL query into respective Map processing task and Reduce processing task based on such analysis result, and creates an execution plan of these Map processing task and Reduce processing task (S2). Further, the query conversion unit 43 refers to the accelerator information table 44 (FIG. 3) (S3) and determines whether or not the task executable by the accelerator 34 of the worker node server 7 exists among the Map processing task and the Reduce processing task (S4).

When obtaining a negative result in this determination, the query conversion unit 43 transmits the SQL query given from the analysis BI tool 41 as it is to the master node server 6 of the distributed database system 4 (S5), and thereafter, ends this query conversion processing.

In contrast, when obtaining a positive result in a determination of step S4, the query conversion unit 43 converts such SQL query into the SQL query in which the task (the Map processing task or the Reduce processing task) executable by the accelerator 34 of the worker node server 7 is defined by the user-defined function (S6), further, other task is defined by the SQL (S7).

Then, the query conversion unit 43 transmits the converted SQL query to the master node server 6 of the distributed database system 4 (S8), and thereafter ends the query conversion processing.

### (1-2-2) Processing of Master Node Server

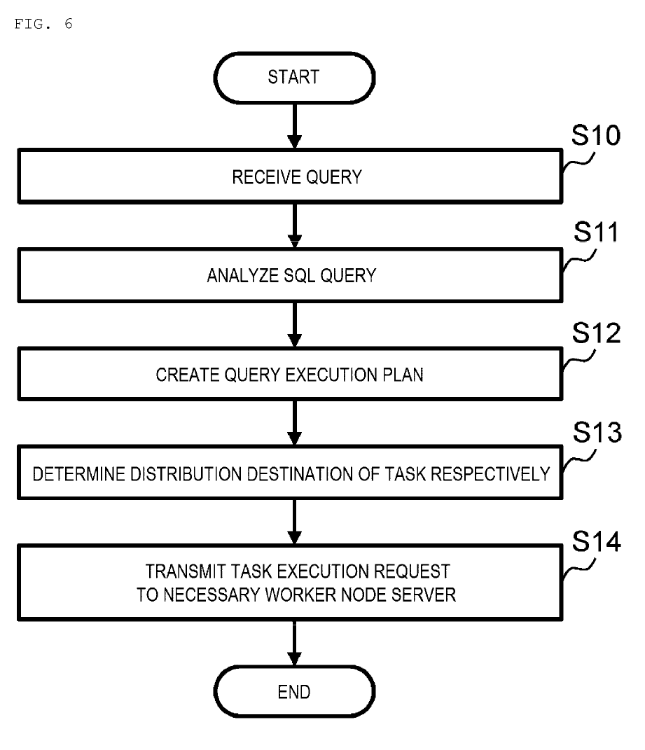

Meanwhile, FIG. 6 shows a flow of a series of processing executed in the master node server 6 to which the SQL query is transmitted from the application server 3.

When the SQL query is transmitted from the application server 3, a processing shown in FIG. 6 is started in the master node server 6, firstly, the Thrift server unit 45 (FIG. 2) receives the SQL query (S10), thereafter, the query parser unit 46 (FIG. 2) analyzes this SQL query (S11).

The query planner unit 47 (FIG. 2) divides the content of the processing specified in the SQL query into the Map processing task and the Reduce processing task and creates execution plans of these Map processing task and Reduce processing task based on the analysis result (S12).

Thereafter, the resource management unit 48 (FIG. 2) determines the worker node server 7 which is a distribution destination for the Map processing task or the Reduce processing task for each task according to the execution plans created by the query planner unit 47 (S13).

Next, the task management unit 49 (FIG. 2) transmits a task execution request that the Map processing task or the Reduce processing task distributed to the worker node server 7 should be executed to the corresponding worker node server 7 according to the determination of the resource management unit 48 (S14). Thus, the processing of the master node server 6 is ended.

### (1-2-3) Processing of Worker Node Server

### (1-2-3-1) Map Processing

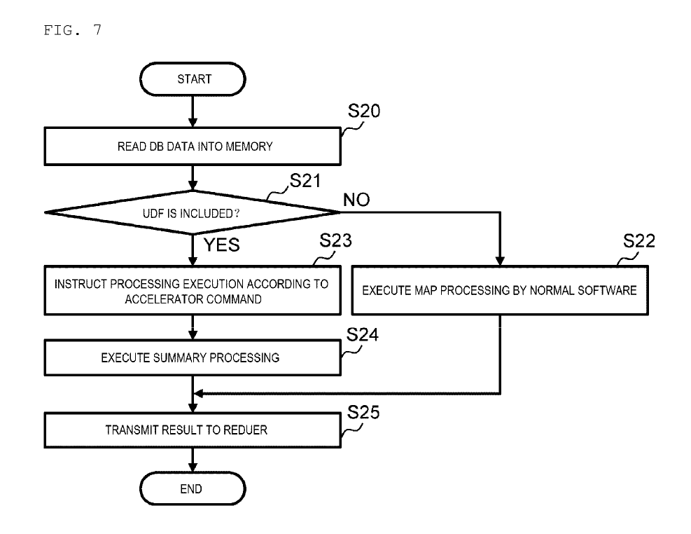

FIG. 7 shows a flow of a series of processing executed in the worker node server 7 to which a task execution request that the Map processing should be executed is given.

When the task execution request of the Map processing task is given from the master node server 6 to the worker node server 7, the processing shown in FIG. 7 is started in the worker node server 7, firstly, the scan processing unit 50 (FIG. 2) reads the necessary database data 58 (FIG. 2) from the local drive 32 (FIG. 1) into the memory 31 (FIG. 1) (S20). At this time, when the database data 58 is compressed, the scan processing unit 50 applies necessary data processing to the database data 58, such as decompression.

Then, the processing switching unit 54 (FIG. 2) determines whether or not the user-defined function is included in the task execution request given from the master node server 6 (S21).

When obtaining a negative result in this determination, the processing switching unit 54 activates a necessary processing unit among the aggregate processing unit 51 (FIG. 2), the join processing unit 52 (FIG. 2), and the filter processing unit 53 (FIG. 2) to sequentially execute one or a plurality of Map processing tasks included in the task execution request (S22). Further, the processing unit that executes such Map processing task transmits a processing result to the worker node server 7 to which the Reduce processing task is allocated (S25). Thus, the processing in the worker node server 7 is ended.

In contrast, when obtaining a positive result in the determination of step S21, the processing switching unit 54 causes the aggregate processing unit 51, the combining processing unit 52 and the filter processing unit 53 to execute the Map processing task and the Reduce processing task which are not defined by the user-defined function, and meanwhile, in parallel with this, calls the accelerator control unit 55 (FIG. 2).

Further, the accelerator control unit 55 called by the processing switching unit 54 generates one or a plurality of necessary accelerator commands based on the user-defined function included in the task execution request, and causes the accelerator 34 to execute the Map processing task defined by the user-defined function by sequentially giving the generated accelerator commands to the accelerator 34 (S23).

Further, when the Map processing task is completed by the accelerator 34, the accelerator control unit 55 executes the summary processing summarizing the processing result (S24), and thereafter, transmits a processing result of the summary processing and a processing result of the Map processing task that undergoes software processing to the worker node server 7 to which the Reduce processing is allocated (S25). Thus, the processing in the worker node server 7 is ended.

### (1-2-3-2) Reduce Processing

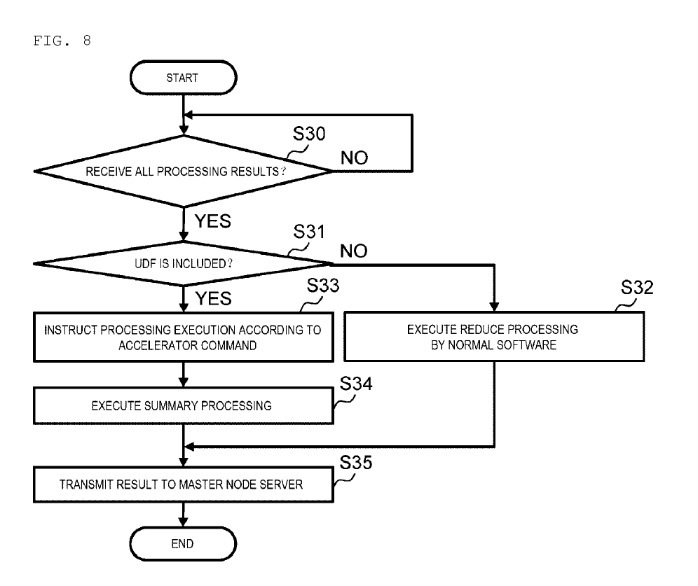

Meanwhile, FIG. 8 shows a flow of a series of processing executed in the worker node server 7 to which a task execution request that the Reduce processing task should be executed is given.

When the task execution request of the Reduce processing task is given from the master node server 6 to the worker node server 7, the processing shown in FIG. 8 is started in the worker node server 7, firstly, the processing switching unit 54 waits for the processing result of the Map processing task necessary for executing the Reduce processing to be transmitted from other worker node server 7 (S30).

Further, when receiving all necessary processing results of the Map processing task, the processing switching unit 54 determines whether or not the user-defined function is included in the task execution request given from the master node server 6 (S31).

When obtaining a negative result in this determination, the processing switching unit 54 activates the necessary processing unit among the aggregate processing unit 51, the join processing unit 52, and the filter processing unit 53 to execute the Reduce processing task (S32). Further, the processing unit that executes the Reduce processing task transmits the processing result to the master node server 6 (S35). Thus, the processing in the worker node server 7 is ended.

In contrast, when obtaining a positive result in the determination of step S31, the processing switching unit 54 calls the accelerator control unit 55. Further, the accelerator control unit 55 called by the processing switching unit 54 generates one or a plurality of necessary accelerator commands based on the user-defined function included in the task execution request, and causes the accelerator 34 to execute the Reduce processing task defined by the user-defined function by sequentially giving the generated accelerator commands to the accelerator 34 (S33).

Further, when the Reduce processing task is completed by the accelerator 34, the accelerator control unit 55 executes a summary processing summarizing the processing result (S34), and thereafter transmits the processing result of the summary processing to the master node server 6 (S35). Thus, the processing in the worker node server 7 is ended.

### (1-3) A Flow of Analysis Processing in Information Processing System

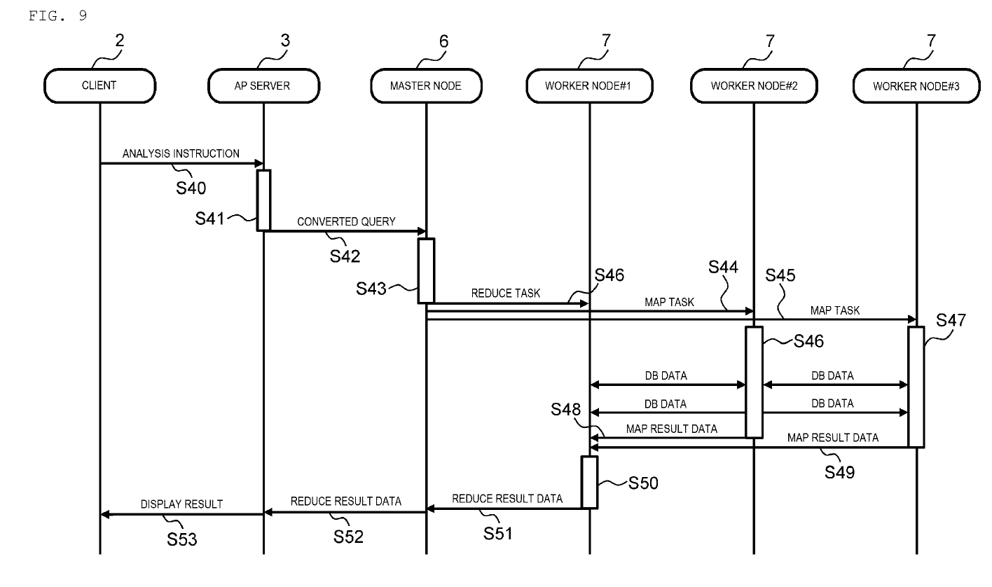

FIG. 9 shows an example of a flow of analysis processing in the information processing system 1 as described above. Such analysis processing is started by giving an analysis instruction specifying an analysis condition from the client 2 to the application server 3 (S40).

When the analysis instruction is given and the SQL query is generated based on the analysis instruction, the application server 3 converts the generated SQL query into an SQL query in which the task executable by the accelerator 34 of the worker node server 7 is defined by the user-defined function and other task is defined by the SQL (S41). Further, the application server 3 transmits the converted SQL query to the master node server 6 (S42).

When the SQL query is given from the application server 3, the master node server 6 creates a query execution plan and divides the SQL query into the Map processing task and the Reduce processing task. Further, the master node server 6 determines the worker node server 7 to which these divided Map processing task and Reduce processing task are distributed (S43).

Further, the master node server 6 transmits the task execution requests of the Map processing task and the Reduce processing task to the corresponding worker node server 7 respectively based on such determination result (S44 to S46).

The worker node server 7 to which the task execution request of the Map processing task is given exchanges the database data 58 (FIG. 2) with other worker node server 7 as necessary, and executes the Map processing task specified in the task execution request (S46 and S47). Further, when the Map processing task is completed, the worker node server 7 transmits the processing result of the Map processing task to the worker node server 7 to which the Reduce processing task is allocated (S48 and S49).

Further, when the processing result of the Map processing task is given from all the worker node servers 7 to which the related Map processing task is allocated, the worker node server 7 to which the task execution request of the Reduce processing task is given executes the Reduce processing task specified in the task execution request (S50). Further, when the Reduce processing task is completed, such worker node server 7 transmits the processing result to the master node server 6 (S51).

The processing result of the Reduce processing task received by the master node server 6 at this time is the processing result of the SQL query given from the application server 3 by the master node server 6 at that time. Thus, the master node server 6 transmits the received processing result of the Reduce processing task to the application server 3 (S52).

When the processing result of the SQL query is given from the master node server 6, the application server 3 executes the analysis processing based on the processing result and displays the analysis result on the client 2 (S53).

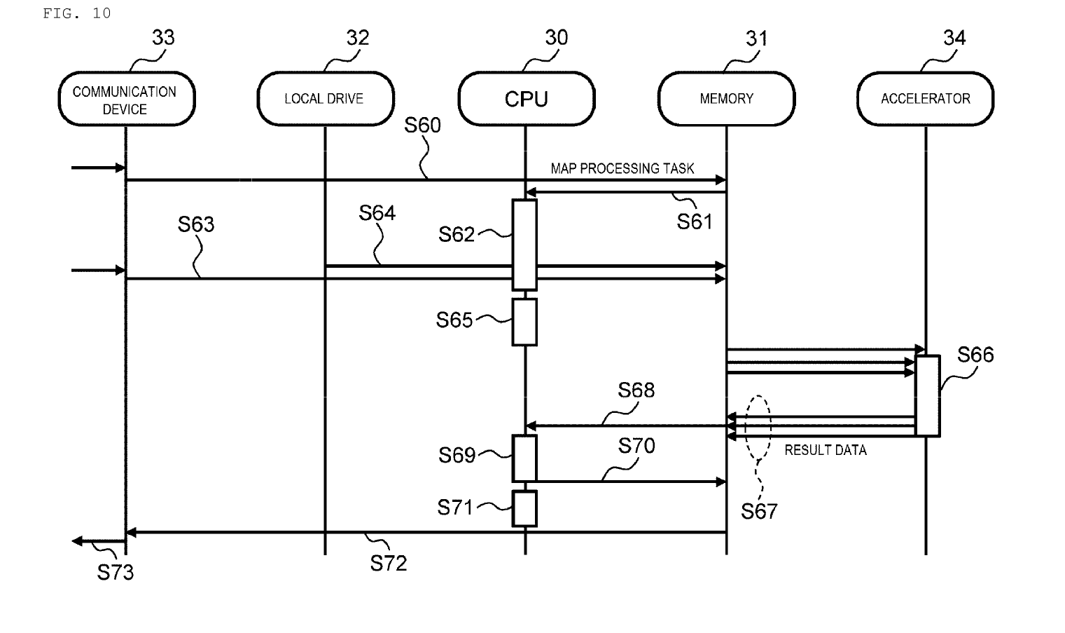

Meanwhile, FIG. 10 shows an example of a processing flow of the Map processing task executed in the worker node server 7 to which the task execution request of the Map processing task is given from the master node server 6. FIG. 10 is an example of a case where the Map processing task is executed in the accelerator 34.

Since various processing executed by the scan processing unit 50, the aggregate processing unit 51, the join processing unit 52, the filter processing unit 53, the processing switching unit 54, and the accelerator control unit 55 are eventually executed by the CPU 30, processing of the CPU 30 is used in FIG. 10.

When receiving the task execution request of the Map processing task transmitted from the master node server 6, the communication device 33 stores the task execution request in the memory 31 (S60). Then, the task execution request is read from the memory 31 by the CPU 30 (S61).

When reading the task execution request from the memory 31, the CPU 30 instructs transfer of necessary database data 58 (FIG. 2) to other worker node server 7 and the local drive 32 (S62). Further, the CPU 30 stores the database data 58 transmitted from other worker node server 7 and the local drive 32 in the memory as a result (S63 and S64). Further, the CPU 30 instructs the accelerator 34 to execute the Map processing task according to such task execution request (S65).

The accelerator 34 starts the Map processing task according to an instruction from the CPU 30, and executes necessary filter processing and aggregate processing (S66) while appropriately reading the necessary database data 58 from the memory 31. Then, the accelerator 34 appropriately stores the processing result of the Map processing task in the memory 31 (S67).

Thereafter, the processing result of such Map processing task stored in the memory 31 is read by the CPU 30 (S68). Further, the CPU 30 executes the summary processing summarizing the read processing results (S69), and stores the processing result in the memory 31 (S70). Thereafter, the CPU 30 gives an instruction to the communication device 33 to transmit the processing result of such result summary processing to the worker node server 7 to which the Reduce processing is allocated (S71).

Thus, the communication device 33 to which such instruction is given reads the processing result of the result summary processing from the memory 31 (S72), and transmits the processing result to the worker node server 7 to which the Reduce processing is allocated (S73).

### (1-4) Effect of the Present Embodiment

In the information processing system 1 according to the present embodiment as described above, the application server 3 converts the SQL query generated by the analysis BI tool 41 which is the application into the SQL query in which the task executable by the accelerator 34 of the worker node server 7 of the distributed database system 4 is defined by the user-defined function and other task is defined by the SQL; the master node server 6 divides the processing of the SQL query for each task, and allocates these tasks to each worker node server 7; each worker node server 7 executes the task defined by the user-defined function in the accelerator 34, and processes the task defined by the SQL by the software.

Therefore, it is possible to improve the performance per worker node server 7 by causing the accelerator 34 to execute some tasks without requiring alteration of the analysis BI tool 41, for example, according to the information processing system 1. At this time, the information processing system 1 does not require the alteration of the analysis BI tool 41. Therefore, it is possible to prevent an increase in system scale for high-speed processing of large-capacity data without requiring the alteration of the application, and to prevent an increase in introduction cost and maintenance cost according to the information processing system 1.

(2) Second Embodiment 60 shows an information processing system according to a second embodiment as a whole in FIG. 1 and FIG. 2. When the accelerator 63 of a worker node server 62 of the distributed database system. 61 executes the Map processing task allocated from the master node server 6, in a case where necessary database data 58 (FIG. 2) is acquired from other worker node server 7 or the local drive 32, the information processing system 60 is configured similarly to the information processing system 1 according to the first embodiment except that the database data 58 is acquired directly from other worker node server 7 or the local drive 32 without going through the memory 31.

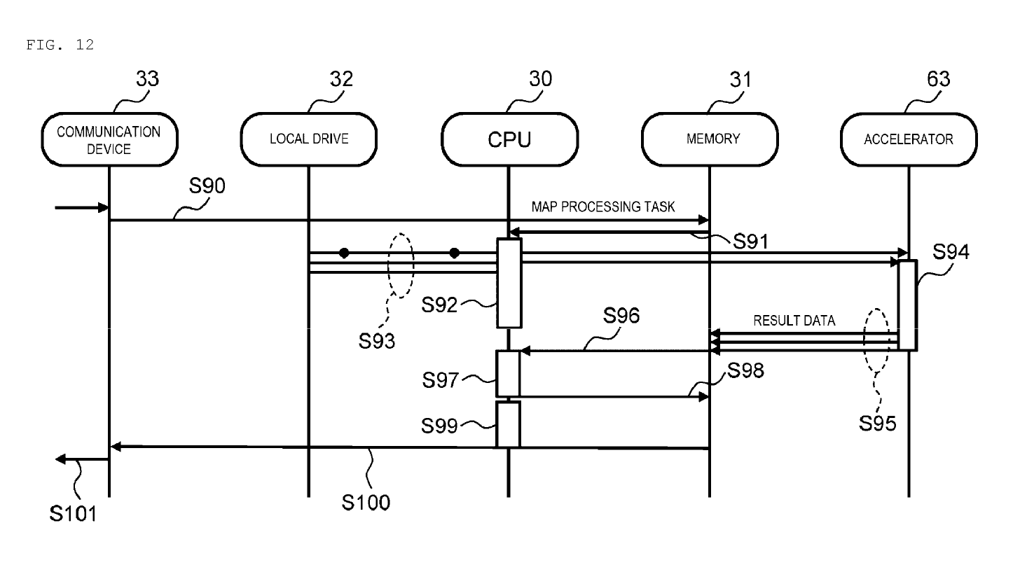

In practice, in the information processing system 1 according to the first embodiment, the transfer of the database data 58 from other worker node server 7 or the local drive 32 to the accelerator 34 is performed via the memory 31 as described above with reference to FIG. 10. In contrast, in the information processing system 60 of the present embodiment, the transfer of the database data 58 from other worker node server 7 or the local drive 32 to the accelerator 34 is performed directly without going through the memory 31 as shown in FIG. 12 to be described later, which is different from the information processing system 1 according to the first embodiment.

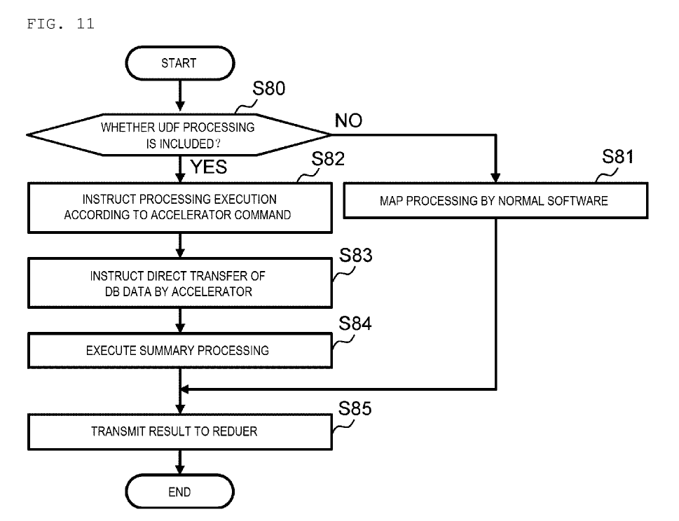

FIG. 11 shows a flow of a series of processing executed in the worker node server 62 to which the task execution request of, for example, the Map processing task is given from the master node server 6 of the distributed database system 61 in the information processing system 60 according to the present embodiment.

When the task execution request of the Map processing is given from the master node server 6 to the worker node server 62, the processing shown in FIG. 11 is started in the worker node server 62, firstly, the processing switching unit 54 described above with reference to FIG. 2 determines whether or not the user-defined function is included in the task execution request (S80).

When obtaining a negative result in this determination, the processing switching unit 54 activates a necessary processing unit among the aggregate processing unit 51, the join processing unit 52, and the filter processing unit 53 to execute the task of the Map processing (S81). Further, the processing unit that executes such Map processing task transmits the processing result to the worker node server 62 to which the Reduce processing task is allocated (S85). Thus, the processing in the worker node server 62 is ended.

In contrast, when obtaining a positive result in the determination of step S80, the processing switching unit 54 causes the aggregate processing unit 51, the join processing unit 52 and the filter processing unit 53 to execute the Map processing task and the Reduce processing task which are not defined by the user-defined function, and meanwhile, in parallel with this, calls the accelerator control unit 55.

Further, the accelerator control unit 55 called by the processing switching unit 50 converts the user-defined function included in the task execution request into a command used for the accelerator and instructs the accelerator 63 to execute the Map processing task by giving the command to the accelerator 63 (FIG. 1 and FIG. 2) (S82).

When such instruction is given, the accelerator 63 gives the instruction to the local drive 32 or other worker node server 62 to directly transfer the necessary database data (S83). Thus, the accelerator 63 executes the Map processing task specified in the task execution request by using the database data transferred directly from the local drive 32 or the other worker node server 62.

Then, when the Map processing is completed by the accelerator 63, the accelerator control unit 55 executes the result summary processing summarizing the processing results (S84), and thereafter, transmits the processing result of the result summary processing and the processing result of the Map processing task that undergoes the software processing to the worker node server 62 to which the Reduce processing is allocated (S85). Thus, the processing in the worker node server 62 is ended.

FIG. 12 shows an example of a flow of the Map processing task in the worker node server 62 to which the task execution request of the Map processing task is given from the master node server 6 in the information processing system 60 of the present embodiment. FIG. 12 is an example of a case where such Map processing task is executed in the accelerator 63.

As in the case of FIG. 10, various processing to be executed by the scan processing unit 50, the aggregate processing unit 51, the join processing unit 52, the filter processing unit 53, the processing switching unit 54, and the accelerator control unit 55 in FIG. 2 are also described as the processing by the CPU 30 in the FIG. 12.

When receiving the task execution request of the Map processing task transmitted from the master node server 6, the communication device 33 stores the task execution request in the memory 31 (S90). Thereafter, the task execution request is read from the memory 31 by the CPU 30 (S91).

When reading the task execution request from the memory 31, the CPU 30 gives the instruction to the accelerator 63 to execute the Map processing task according to the task execution request (S92). Further, the accelerator 63 receiving the instruction requests the transfer of necessary database data to the local drive 32 (or other worker node server 62). As a result, the necessary database data is directly given from the local drive 32 (or other worker node server 62) to the accelerator 63 (S93).

Further, the accelerator 63 stores the database data transferred from the local drive 32 (or other worker node server 62) in the DRAM 35 (FIG. 1), and executes the Map processing such as the necessary filter processing and aggregate processing while appropriately reading the necessary database data from the DRAM 35 (S94). Further, the accelerator 63 appropriately stores the processing result of the Map processing task in the memory 31 (S95).

Thereafter, the processing similar to the step S68 to step S71 in FIG. 10 is executed in step S96 to step S99, and thereafter the processing result of the summary processing executed by the CPU 30 is read from the memory 31 by the communication device 33 (S100), and the processing result is transmitted to the worker node server 62 to which the Reduce processing is allocated (S101).

Since the accelerator 63 directly acquires the database data 58 from the local drive 32 without going through the memory 31 according to the information processing system 60 of the present embodiment as described above, it is unnecessary to transfer the database data from the local drive 32 to the memory 31 and transfer the database data from the memory 31 to the accelerator 63 so as to reduce the necessary data transfer bandwidth of the CPU 30 and to perform data transfer with low delay, and as a result, the performance of the worker node server 62 can be improved.

### (3) Other Embodiment

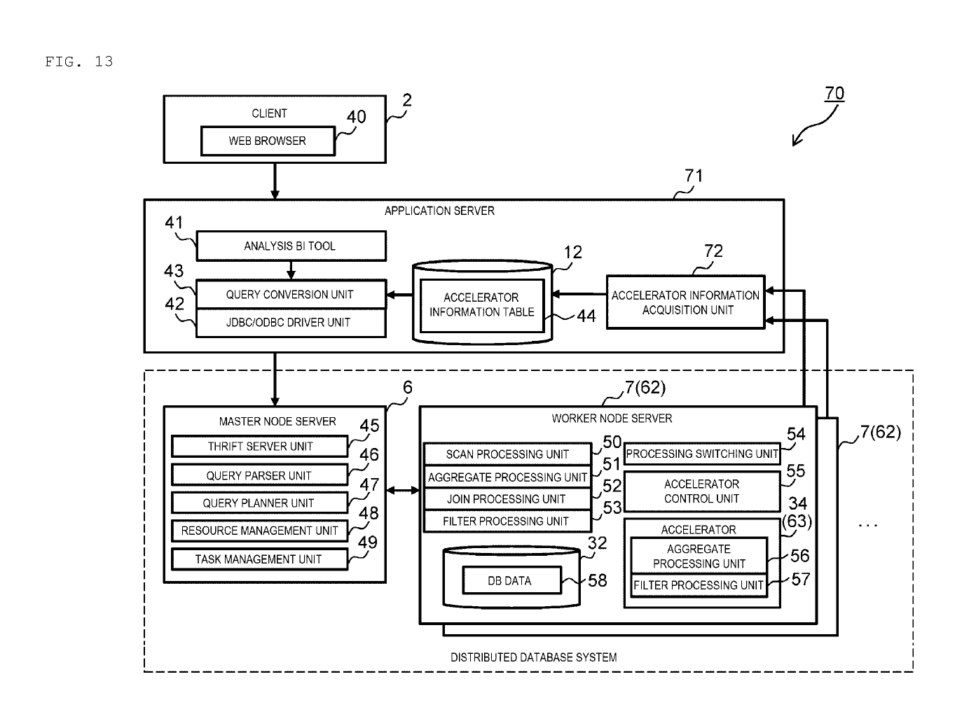

Although a case where the hardware specification information of the accelerators 34, 63 stored in the accelerator information table 44 (FIG. 2) held by the application server 3 is stored previously by a system administrator and the like is described in the first embodiment and the second embodiment, the invention is not limited to this, for example, as shown in FIG. 13 in which the same reference numerals are given to parts corresponding to FIG. 2, an accelerator information acquisition unit 72 that collects the hardware specification information of the accelerators 34, 63 mounted on the worker node servers 7 and 62 from the each worker node servers 7, 62 is provided in an application server 71 of an information processing system 70, and the accelerator information acquisition unit 72 may store the hardware specification information of the accelerators 34, 63 of the worker node servers 7, 62 collected periodically or non-periodically in the accelerator information table 44 or may update the accelerator information table 44 based on the collected hardware specification information of each accelerator 34. In this way, even when the accelerators 34, 63 are exchanged, or when the worker node servers 7, 62 are added, it is possible for the application server 71 to always perform the SQL query conversion processing based on latest accelerator information (the hardware specification information of the accelerators 34, 63).

The accelerator information acquisition unit 72 may have a software configuration embodied by executing the program stored in the memory 11 by the CPU 10 of the application server 3 or a hardware configuration including dedicated hardware.

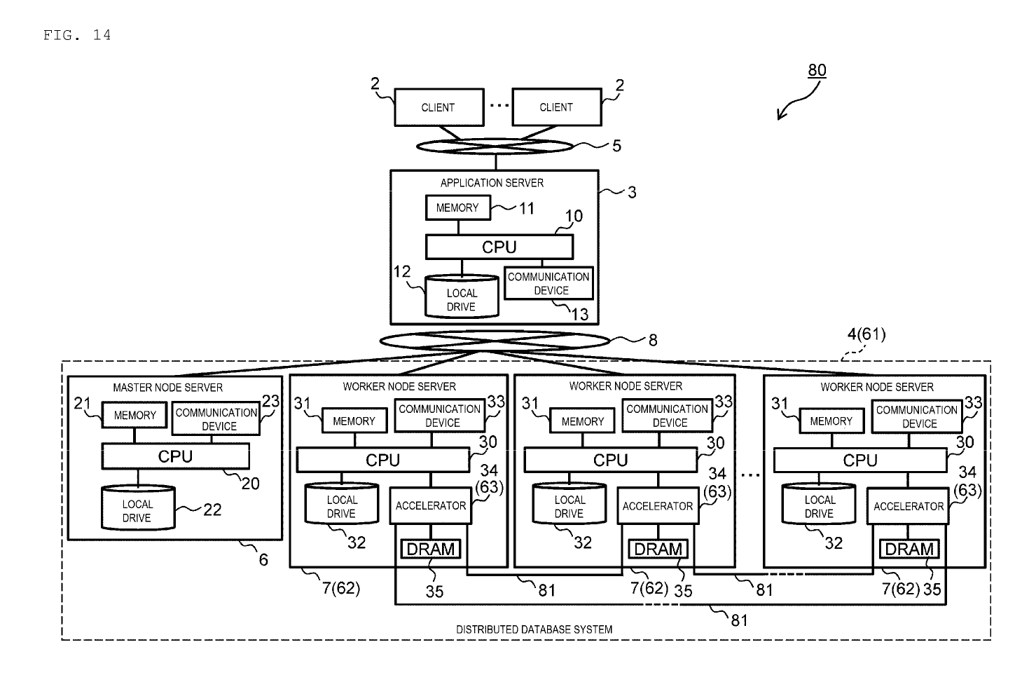

Although a case where communication between the worker node servers 7, 62 is performed via the second network 8 is described in the first embodiment and the second embodiment, the invention is not limited to this, for example, as shown in FIG. 14 in which the same reference numerals are given to parts corresponding to FIG. 1, the accelerators 34, 63 of the worker node servers 7, 62 may be connected by a daisy chain via a high-speed serial communication cable 81, the accelerators 34, 63 of all the worker node servers 7, 62 may be connected to each other via the high-speed serial communication cable 81, an information processing system 80 may be constructed such that the necessary data such as database data is exchanged between the worker node servers 7, 62 via these cables 81.

Further, although a case where the application (a program) mounted on the application server 3 is the analysis BI tool 41 is described in the first and second embodiments, the invention is not limited to this, the invention can be widely applied even if the application is other than the analysis BI tool 41.

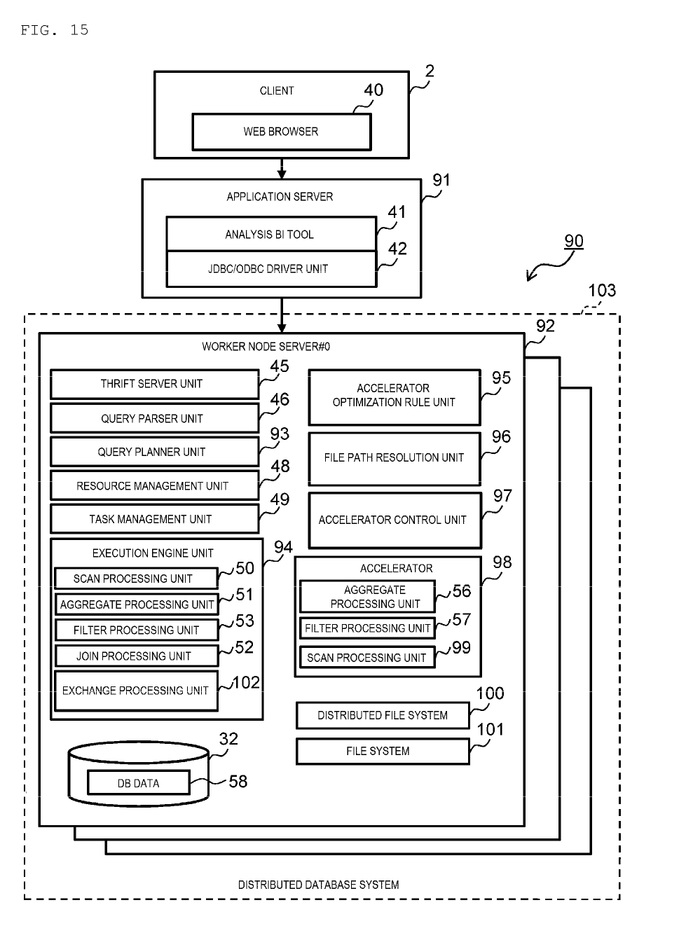

(4) Third Embodiment 90 shows an information processing system according to third embodiment as a whole in FIG. 1 and FIG. 15. In the information processing system 1 according to the first embodiment, the query explicitly divided into the first task executable by the accelerator by the query conversion unit 43 shown in FIG. 2 and the second task that should be executed by the software. In contrast, in the information processing system. 90 of the present embodiment, a query output by the analysis BI tool 41 (FIG. 15) is transmitted to a worker node server 92 via the JDBC/ODBC driver 42 (FIG. 15) without conversion, next a query plan suitable for accelerator processing by a query planner unit 93 in the worker node server 92 is converted and generated and the query plan is executed by an execution engine in each worker node, which is different from the information processing system according to the first embodiment.

FIG. 15 shows a logical configuration of the information processing system 90 in the third embodiment. Parts having the same functions as those already described are denoted by the same reference signs, and description thereof is omitted.

The worker node server 92 has a combined function of the master node server 6 and the worker node server 7 (62) in FIG. 1 and FIG. 2. The hardware configuration is the same as that of the worker node server 7 in FIG. 1.

The query received from the application server 91 is first analyzed by the query parser unit 46. The query planner unit 93 cooperates with an accelerator optimization rule unit 95 to generate the query plan suitable for accelerator processing by using the query analyzed by the query parser unit 46.

The accelerator optimization rule unit 95 applies a query plan generation rule optimized for the accelerator processing taking account of constraint conditions of the accelerator using the accelerator information table 44 (FIG. 3) in the local drive 32.

A file path resolution unit 96 searches and holds conversion information from storage location information on a distributed file system 100 (a distributed file system path) and storage location information on a local file system 101 (a local file system path) of a database file, and responds to the file path inquiry.

An execution engine unit 94 includes the join processing unit 52, the aggregate processing unit 51, the filter processing unit 53, the scan processing unit 50, and the exchange processing unit 102, and executes the query plan in cooperation with an accelerator control unit 97 and an accelerator 98 (so-called software processing).

The distributed file system 100 is configured as one single file system by connecting a plurality of server groups with a network. An example of the distributed file system is Hadoop Distributed File System (HDFS).

A file system 101 is one of the functions possessed by an operating system (OS), manages logical location information (Logical Block Address (LBA) and size) and the like of the file stored in the drive, and provides a function to read data on the drive from the location information of the file in response to a read request based on a file name from the application and the like.

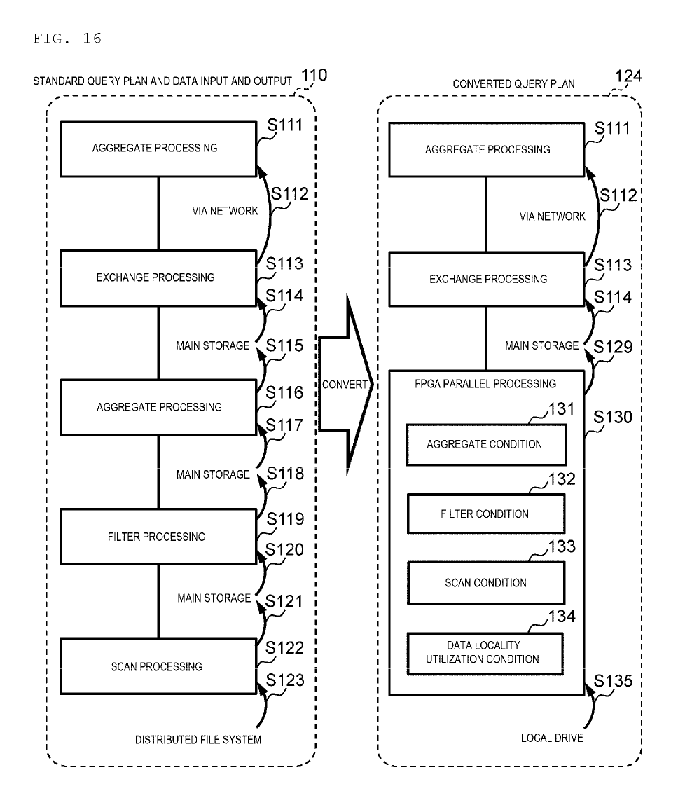

FIG. 16 is a diagram explaining a query plan execution method and a query plan conversion method according to the third embodiment.

A standard query plan 110 is a query plan generated first by the query planner unit 93 from an input query. The standard query plan may be converted into a converted query plan 124 as will be described later or may be executed by the execution engine unit 94 without conversion. The standard query plan 110 shows that processing is executed in the order of scan processing S122, filter processing S119, aggregate processing S116, exchange processing S113, and aggregate processing S111 from the processing in the lower part of the drawing.

The scan processing S122 is performed by the scan processing unit 50, and includes: reading the database data from the distributed file system 100 (S123); converting the database data into an in-memory format for the execution engine unit, and storing the converted database data in a main storage (a memory 31 (FIG. 1)) (S121).

The filter processing S119 is performed by the filter processing unit 53, and includes: reading the scan processing result data from the main storage (S120); determining whether or not each line data matches the filter condition; making a hit determination on the matching line data; and storing the result in the main storage (S118) (filter processing).

The first aggregate processing (the aggregate processing) S116 is performed by the aggregate processing unit 51, and includes: reading the hit-determined line data from the main storage (S117); executing the processing according to the aggregate condition; and storing the aggregate result data in the main storage (S115).

The exchange processing S113 is performed by the exchange processing unit 102, and includes: reading aggregate result data from the main storage (S114); and transferring the aggregate result data to the worker node server 92 that executes the second aggregate processing (the summary processing) described later on S111 via the network (S112).

In the second aggregate processing (the summary processing) S111, the worker node server 92 in charge of the summary executes summary aggregate processing of the aggregate result data collected from each worker node server 92, and transmits the aggregate result data to the application server 91.

The converted query plan 124 is converted and generated by the accelerator optimization rule unit 95 based on the standard query plan 110. The query plan to be processed by the accelerator 98 is converted, and the query plan processed by the execution engine unit is not converted. The specification information of the accelerator and the like are referred to determine which processing is appropriate, and decide the necessity of conversion. The converted query plan 124 shows that processing is executed in the order of FPGA parallel processing S130, exchange processing S113, and aggregate processing S111 from the processing in the lower part of the drawing.

The FPGA parallel processing S130 is performed by the accelerator 98 (the scan processing unit 99, the filter processing unit 57, and the aggregate processing unit 56), and includes: reading the database data of the local drive 32 (S135) and performing the scan processing, the filter processing, and the aggregate processing according to an aggregate condition 131, a filter condition 132, a scan condition 133, and a data locality utilization condition 134; and thereafter, format-converting the processing result of the accelerator 99 and storing the processing result in the main storage (S129). The accelerator optimization rule unit 95 detects the scan processing S122, the filter processing S119, and the aggregate processing S116 that exist in the standard query plan, collects the conditions of the processing and sets as the aggregate condition, the filter condition, and the scan condition of the FPGA parallel processing S130. The aggregate condition 131 is information necessary for the aggregate processing such as an aggregate operation type (SUM/MAX/MIN), a grouping target column, an aggregate operation target column, the filter condition 132 is information necessary for the filter processing such as comparison conditions (=, >, < and the like) and comparison target columns, and the scan condition 133 is information necessary for the scan processing of location information on the distributed file system of the database data file of read target (a distributed file system path) and the like. The data locality utilization condition 134 is a condition for targeting the database data file which exists in the file system 101 on the own worker node server 92 as a scan processing target. The FPGA parallel processing S130 is executed by the accelerator 99 according to an instruction from the accelerator control unit 97.

The exchange processing S113 and the second aggregate processing S111 are performed by the exchange processing unit 102 and the aggregate processing unit 51 in the execution engine unit 94 similarly to the standard query plan. These processing units may be provided in the accelerator 99.

Since the standard query plan 110 is assumed to be processed by CPU, in each processing of scan, filter, and aggregate, the basic operation is to place data in the main storage or read from the main storage at the start and completion of the processing. Data input/output of such main storage causes data movement between the CPU and the memory, which is a factor of lowering the processing efficiency. In the query plan conversion method according to the invention, each processing can undergo pipeline parallel processing within the accelerator by converting each processing to a new integrated FPGA parallel processing S130, and the movement of data between the FPGA and the memory is unnecessary, thereby improving the processing efficiency.

Further, since the scan processing S122 in the standard query plan acquires the database data from the distributed file system 100, database data may be acquired from other worker node server 92 via the network according to the data distribution situation of the distributed file system 100. In the query plan conversion according to the invention, it is possible to efficiently operate the accelerator by ensuring that the accelerator 98 can reliably acquire the database data from the neighboring local drive.

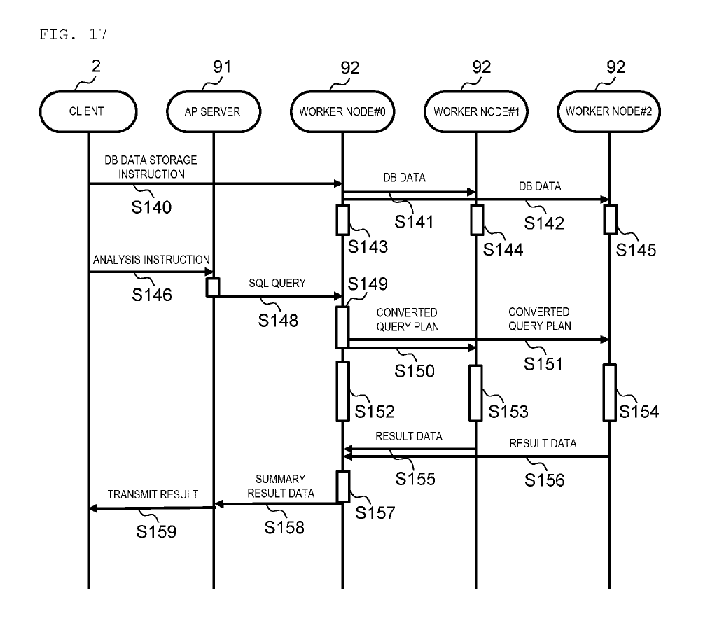

FIG. 17 is a diagram explaining an entire sequence in the third embodiment.

The client 2 first instructs a database data storage instruction to the distributed file system 100 (S140). The distributed file system 100 of the summarized worker node server #0 divides the database data into a block of a prescribed size and transmits a copy of the data to other worker node server for replication (S141 and S142). In each worker node, the file path resolution unit 96 detects that the block of the database data is stored according to an event notification from the distributed file system 100, and then, a correspondence table between the distributed file system path and the local file system path is created by searching the block on the local file system 101 on each server 92 (S143, S144 and S145). The correspondence table may be updated each time the block is updated, or may be stored and saved in a file as a cache.

Next, the client 2 transmits the analysis instruction to the application server (S146). The application server 91 transmits the SQL query to the distributed database system. 103 (S148). The worker node server #0 that received the SQL query converts the query plan as described above and transmits the converted query plan (and the non-converted standard query plan) to other worker node servers #1 and #2 (S150 and S151).

Each of the worker nodes #0, #1 and #2 offloads the scan processing, the filter processing, and the aggregate processing of the FPGA parallel processing to the accelerator 98 for execution (S152, S153 and S154). The non-converted standard query plan is executed by the execution engine 94. Then, the worker node servers #1 and #2 transmit the result data output by the accelerator 98 or the execution engine 94 to the worker node server #0 for summary processing (S155 and S156).

The worker node server #0 executes the summary processing of the result data (S157), and transmits the summary result data to the application server (S158). The application server transmits the result to the client used for displaying to the user (S159).

Although the query conversion is performed by the worker node server #0 in the embodiment, the query conversion may be performed by the application server or individual worker node servers #1 and #2.

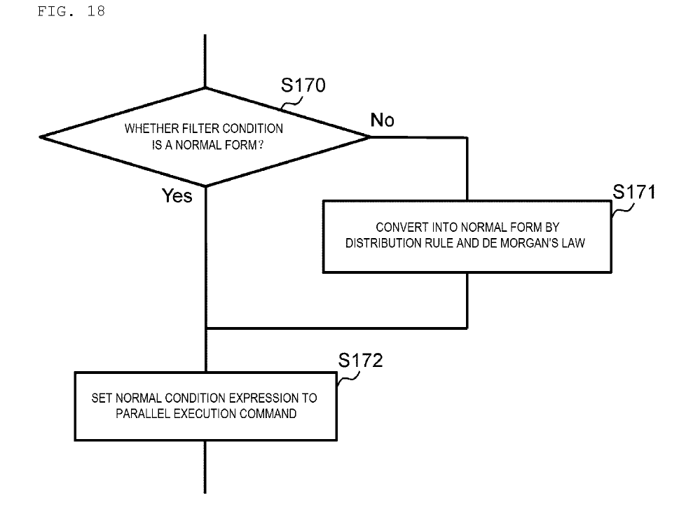

FIG. 18 is a diagram explaining a processing flow showing that the accelerator control unit 97 converts the filter condition set in the query plan by the accelerator optimization rule unit 95 into a form suitable for parallel processing in the third embodiment.

The accelerator control unit 97 determines whether the filter condition is a normal form (S170). If the filter condition is not the normal form, it is converted into the normal form by a distribution rule and a De Morgan's law (S171). Then, a normal form filter condition expression is set to a parallel execution command of the accelerator (S172). The normal form is a conjunctive normal form (a multiplicative normal form) or a disjunctive normal form (an additive normal form).

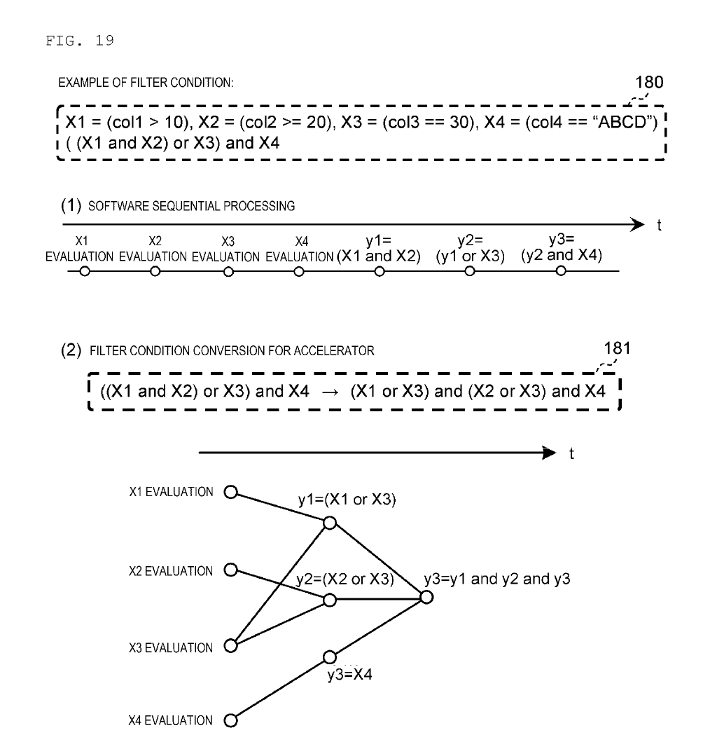

Further, an example of the conversion of the filter condition is shown in FIG. 19. A filter condition 180 before the conversion includes a column magnitude comparison (X1=(col1>10), X2=(col2>=20)) or a match comparison (X3=(col3==30) and X4=(col4==“ABDC”)), and a logical sum and a logical product thereof (((X1 and X2) or X3) and X4). In the sequential processing by the related-art software (1), firstly, the comparative evaluation of the column is executed sequentially, then the logical sum and the logical product are sequentially performed from those in inner parentheses. In the filter condition conversion for the accelerator (2), the filter conditional expression is converted to the conjunctive normal form (181). Since the conjunctive normal form takes a form of logical product (and) including one or more logical sum (or) of comparative evaluation, as shown in the drawing, the comparison evaluation, the logical sum, and the logical product can be processed in parallel in this order.

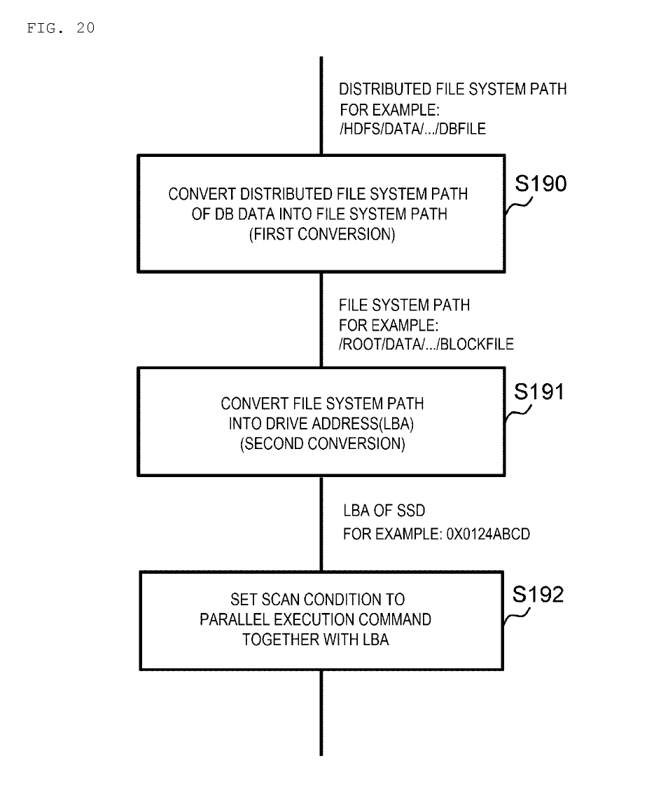

FIG. 20 is a diagram showing a conversion flow from the distributed file system path to the LBA and size information necessary for the scan processing of the accelerator in the third embodiment. The scan condition 133 included in the converted query plan includes a distributed file system path (for example: /hdfs/data/ . . . /DBfile) which is the location information of the target database data. The accelerator control unit 97 converts the distributed file system path into a file system path (for example: /root/data/ . . . /blockfile) by inquiring the file path resolution unit 96 as a first conversion (S190).

Then, the accelerator control unit 97 converts the file system path into the LBA (for example: 0x0124abcd . . . ) and size information which is the logical location information of the file on the drive by inquiring the file system of the OS as a second conversion (S191). Finally, the scan condition is set to the parallel execution command together with the LBA and size information (S192).

According to this method, the accelerator does not need to analyze a complicated distributed file system or a file system, and it is possible to directly access the database data of the drive from the LBA and size information in the parallel execution command.

### INDUSTRIAL APPLICABILITY

The invention can be widely applied to an information processing system of various configurations that executes processing instructed from a client based on information acquired from a distributed database system.

### REFERENCE SIGN LIST

60, 70, 80, 90 . . . information processing system; 2 . . . client; 3, 71, 91 . . . application server; 4, 61, 103 . . . distributed database system; 6 . . . master node server; 7, 62, 92 . . . worker node server; 10, 20, 30 . . . CPU; 11, 21, 31 . . . memory; 12, 22, 32 . . . local drive; 34, 63, 98 . . . accelerator; 41 . . . analysis BI tool; 43 . . . query conversion unit; 44 . . . accelerator information table; 45 . . . Thrift server unit; 46 . . . query parser unit; 47 . . . query planner unit; 48 . . . resource management unit; 49 . . . task management unit; 50 . . . scan processing unit; 51, 56 . . . aggregate processing unit; 52 . . . join processing unit; 53, 57 . . . filter processing unit; 54 . . . processing switching unit; 55, 97 . . . accelerator control unit; 58 . . . database data; 72 . . . accelerator information acquisition unit; 81 . . . code; 95 . . . accelerator optimization rule unit, 96 . . . file path resolution unit, 99 . . . scan processing unit, 100 . . . distributed file system, 101 . . . file system.

1. An information processing system that executes processing according to an instruction from a client, the information processing system comprising:
an application server on which an application that executes the processing according to the instruction from the client is mounted; and
a distributed database system that distributes and holds data by a plurality of servers,
wherein the distributed database system includes the plurality of servers on which a processor that operates software used for executing allocated tasks and an accelerator which is hardware capable of executing some or all types of tasks are mounted,
the application server generates a query that acquires information used for executing the processing according to the instruction from the client from the distributed database system and transmits the query to the distributed database system,
a conversion unit divides the query generated by the application server into a first task executed by the accelerator and a second task executed by the software,
the plurality of servers of the distributed database system cause the accelerator to execute the first task that should be executed by the accelerator included in the query, execute the second task that should be executed by the software included in the query based on the software, and return execution results of the first task and/or the second task, and
the application server receives a processing result of the query obtained based on the execution result of the first task and the second task from the distributed database system.

2. The information processing system according to claim 1,
wherein the conversion is performed based on specification information of the accelerator of the server.

3. The information processing system according to claim 2,
wherein the conversion unit included in the application server converts a first query which is the query generated by the application server into a second query which is divided into the first task executed by the accelerator and the second task executed by the software, and
a master node server of the distributed database system receives the second query, divides the second query into the tasks, and allocates each task to the plurality of servers.

4. The information processing system according to claim 2,
wherein the accelerator includes a Field Programmable Gate Array (FPGA) capable of executing a task defined by a prescribed format user-defined function, and
the query is defined by the prescribed format in which the first task is defined by the user-defined function and the second task can be recognized by the software.

5. The information processing system according to claim 4,
wherein the prescribed format recognizable by the software is a format using Structured Query Language (SQL).

6. The information processing system according to claim 3,
wherein the application server includes an accelerator information acquisition unit that acquires the hardware specification information of the accelerator mounted on the server from each of the servers.

7. The information processing system according to claim 1,
wherein the second task is a task in which the software performs a plurality of processing while storing data in a main storage during each processing, and the first task includes a task in which the accelerator performs pipeline parallel processing.

8. The information processing system according to claim 7,
wherein a first query plan suitable for execution by the software is created based on the query and the first query plan is converted into a second query plan suitable for execution by the accelerator.

9. The information processing system according to claim 8,
wherein at least one server among the servers:
changes the query plan to allocate the first task and the second task included in the query to other server, and
receives and summarizes a processing result from other server, and transmits the processing result to the application server.

10. The information processing system according to claim 9,
wherein the first task and the second task to be converted include scan processing, filter processing, and aggregate processing, and
the scan processing, the filter processing, and the aggregate processing undergo pipeline parallel processing in the first task.

11. The information processing system according to claim 10,
wherein the query plan conversion processing of the filter processing is converted into a filter conditional expression capable of undergoing parallel processing in the order of a comparison operation, a logical sum, and a logical product.

12. The information processing system according to claim 10,
wherein each of the plurality of servers includes: a distributed file system including a plurality of servers; a file system including a single server; and a drive that configures the distributed file system and the file system, in the query plan conversion processing of the scan processing:
a distributed file system path included in the task is converted into a file system path,
the file system path is converted into an address in the drive, and
the address in the drive is set to the first task.

13. An information processing method that executes processing according to an instruction from a client, the information processing method comprising:
generating a query that acquires information used for executing processing according to the instruction from the client from a distributed database system and transmitting the query to the distributed database system, by an application server on which an application that executes the processing according to the instruction from the client is mounted;
dividing the query generated by the application server into a first task executed by an accelerator and a second task executed by software by a conversion unit;
causing the accelerator included in the server to execute the first task that should be executed by the accelerator included in the query, executing the second task that should be executed by the software which operates on a processor included in the query based on the software included in the server, and returning execution results of the first task and/or second task, by a plurality of servers of the distributed database system; and
receiving a processing result of the query obtained based on the execution result of the first task and the second task from the distributed data system by the application server.

14. The information processing method according to claim 13,
wherein the conversion is performed based on the specification information of the accelerator of the server.

15. The information processing method according to claim 13,
wherein the second task is a task in which the software performs a plurality of processing while storing data in a main storage during each processing, and the first task includes a task in which the accelerator performs pipeline parallel processing, and
a first query plan suitable for execution by the software is created based on the query and the first query plan is converted into a second query plan suitable for execution by the accelerator.
